(19) United States
(12) Patent Application Publication
(10) Pub. No.: US 2004/0002844 A1
(43) Pub. Date: Jan. 1, 2004

(54) System and method for statistical modeling and statistical timing analysis of integrated circuits

(76) Inventors: Jochen A.G. Jess, Eindhoven (NL); Chandramouli Visweswariah, Croton-on-Hudson, NY (US)

Correspondence Address: Louis J. Percello, Intellectual Property Law Dept., IBM Corporation, P.O. Box 218, Yorktown Heights, NY, 10598, US

(21) Appl. No.: 10/184,329

(22) Filed: Jun. 27, 2002

(51) Int. Cl. G06F 17/50

(52) U.S. Cl. 703/14

(57) ABSTRACT

A comprehensive methodology for statistical modeling and timing of integrated circuits and integrated circuit macros is disclosed with a means for efficiently computing the sensitivities of coefficients of gate delay models to sources of variation. These sensitivities are used to determine the probability distribution of the delay and slew of each gate and wire, as well as the correlations between these delays and slews. Finally, these timing models are used in an inventive statistical static timing analysis method to predict the statistical performance of an integrated circuit or integrated circuit macro.

### FIELD OF THE INVENTION

This invention relates to the field of computer-aided design (CAD) tools for integrated circuits (ICs). More specifically, the invention relates to using statistical methods for delay modeling and static timing analysis of integrated circuits.

### BACKGROUND OF THE INVENTION

FIG. 1 shows a typical prior art flow (100) for nominal modeling and prediction of the timing properties of a digital integrated circuit or integrated circuit macro (portion of an integrated circuit). Box 110 shows the manufacturing process which is characterized by a set of process parameters. These parameters are well-known and varied. A parameter is any physical characteristic of a manufacturing process that determines the behavior of the product being manufactured. Non-limiting examples are temperature of the oven, junction depth and concentration of doping impurities.

These parameters are used to create a device model as shown in Box 120, which captures the electrical behavior of individual devices (such as transistors) and wires. Gates, such as a 2-input NAND gate, are comprised of multiple transistors and wires. The device models of Box 120 are used in Box 130 to create timing models of gates. Device models and timing models are also well-known. Timing models of individual gates often have timing attributes like rising delay, falling delay, rising slew and falling slew associated with them (see “IEEE standard for integrated circuit (IC) delay and power calculation system,” IEEE Standard 1481-1999, 1999, pages 1-390, available at hffp://fp.ieeexplore.ieee.org/ie15/6837/18380/00846710.pdf?isNumber=18380&prod=standards& arnumber=00846710).

Finally, the gate timing models are used to predict timing properties of an entire chip or macro of the chip by means of static timing analysis (see R. B. Hitchcock, Sr., G. L. Smith and D. D. Cheng, “Timing analysis of computer hardware,” IBM Journal of Research and Development pages 100-105, January, 1982), as shown in Box 140. While FIG. 1 depicts the most common steps in modeling processes, devices, gates and integrated circuits, it is to be understood that this is a non-limiting modeling method.

A typical gate delay model is explained in reference to FIG. 2. FIG. 2(a) depicts a particular transition of a 3-input NAND gate in which input A rises and output Y falls, while B and C are held at logic ‘1’. The NAND gate example has an input slew rate, sᵢₙ, for input A and an output a capacitance, Cₒᵤₜ. FIG. 2(b) shows the waveforms of A and Y. The difference between the 50% crossing times of A and Y is the delay of the gate, dₒᵤₜ. The time taken by Y to make its transition is the output slew of the gate, s^{out}. The gate delay model comprises a model for the delay and slew for every valid input-to-output transition (also called pin-to-pin transition). Each such transition will be represented by an edge of the timing graph during static timing analysis. FIG. 2(c) shows the set of edges contributed by the 3-input NAND gate to the timing graph. Note that when A is switching, B and C are held at logic ‘1’ because otherwise the output of the gate would not switch due to the logical behavior of the NAND gate. Repeated circuit simulations of the gate being modeled are performed a priori to measure the output delay and output slew for each possible input-to-output transition. Then the measurements corresponding to each transition are typically fitted to analytic delay and slew models by adjusting the coefficients of the models to minimize the error between the measured delays/slews and those predicted by the model. In this non-limiting example, a typical delay model is shown below:

dₒᵤₜ=a₁+a₂Cₒᵤₜ+a₃sᵢₙ+a₄Cₒᵤₜsᵢₙ

sₒᵤₜ=b₁+b₂Cₒᵤₜ+b₃sᵢₙ+b₄Cₒᵤₜsᵢₙ

where a_{1,2,3,4} and b_{1,2,3,4} are coefficients of the delay model, Cₒᵤₜ is the output capacitance of the gate, sᵢₙ is the slew of the input transition, dₒᵤₜ is the delay of the gate and sₒᵤₜ is the output slew of the gate. The delay/slew models are typically functions of input slew and output capacitive load (the model arguments) as shown in the equations above. These modeling methods are well known. For example, see “IEEE standard for integrated circuit (IC) delay and power calculation system,” IEEE Standard 1481-1999, 1999, pages 1-390, available at http://fp.ieeexplore.ieee.org/iel5/6837/18380/00846710.pdf?isNumber=18380&prod=standards& arnumber=00846710 which is herein incorporated by reference in its entirety.

The gate delay models obtained by the above known procedures are used during static timing analysis to predict the timing properties of an integrated circuit or macro of an integrated circuit. The delay of the critical path of the circuit in late-mode timing analysis dictates the fastest clock frequency at which the circuit can be operated. Since static timing analysis predicts the delay of the critical path, it gives us a method of determining the fastest clock frequency at which the circuit will safely work.

The procedure outlined above works very well to predict the nominal performance of an integrated circuit, i.e., its performance in the absence of variations. Unfortunately, variations are inevitable in any practical situation. There are variations both due to imperfect control of the manufacturing process and due to environmental variations (such as temperature and power-supply voltage). Some of these variations can cause catastrophic defects, resulting in an unrecoverable failure of the circuit. Others cause the timing performance of the circuit to vary, and these variations are called parametric variations. Parametric variations cause manufactured chips to have a range of critical path delays, and therefore to be operable at a range of maximum clock frequencies. Some integrated circuits such as microprocessors are sorted into “bins” depending on their working frequency; chips in the high-frequency bin command the highest price and hence the highest profit. These are called sorted designs. Other chips are required to work at a certain frequency and chips below that performance level are useless. These are called non-sorted designs.

In any case, predicting the parametric variations in the critical path delay is very important. The critical path delay determines the fastest frequency of operation, and its probability distribution in turn determines the yield and profitability of an integrated circuit. Analyzing the parametric variations is a key step in estimating the benefit of design changes to improve the yield (percentage of working parts) of an integrated circuit. “Design for Manufacturability” implies changing the design so as to obtain the highest number of working chips at the highest possible performance so as to maximize profitability.

Variations due to manufacturing are numerous and complex. The variations stem from the lack of perfect control of machines in the fabrication line. Dust contamination in the clean room, mechanical tolerances, lens aberrations, inhomogeneous gas flows, variations in gas pressure, insufficient control of temperature, deposition failures with spinning and lack of perfect surface planarity with polishing are sources of parameter variations. A non-exhaustive set of 35 phenomena giving rise to manufacturing variations is listed on page 12 of Chapter 2 of Simon, P., “Yield Modeling for Deep Sub-Micron IC Design,” Ph.D. dissertation, ISBN 90-75341-28-8, Eindhoven University of Technology, Eindhoven, The Netherlands, December 2001, which is herein incorporated by reference in its entirety.

Variations can be lot-to-lot, wafer-to-wafer, die-to-die and intra-die. The variations can also be functions of the position of a chip on the wafer, or the position of a gate on a die, for example. These variations exhibit complex correlations. The variability in these parameters is clearly stochastic in nature.

One method of predicting the effect of parameter variations is by Monte Carlo analysis in which the space of all possible variations is sampled and a complete analysis of the type shown in FIG. 1 (flow 100) is conducted at each sample point. With a sufficient number of such samples, the distribution of chip performance can be predicted with a measurable confidence. To reduce the number of analyses required, the variations are typically analyzed by so-called “best case,” “nominal” and “worst-case” analyses. The processing and environmental conditions are all assumed to be correlated to produce the best (fastest) possible circuits for the best-case analysis. Likewise, worst-case assumptions are made to predict the slowest performance of the circuit. In each analysis, in reference to FIG. 1, a new set of device models 120 is created, a new set of gate delay models 130 is created and a new static timing analysis 140 is conducted. Thus multiple analyses are conducted to predict the distribution of the performance of the final manufactured product.

### PROBLEMS WITH THE PRIOR ART

Prior art methods such as the Monte Carlo analysis and the best/nominal/worst-case analyses mentioned above suffer from several weaknesses. First, they either ignore or restrict the nature of correlations between the sources of variation. Consequently, the results they predict suffer from inaccuracy, and are often needlessly pessimistic. Second, they can suffer from extremely long computer run times. Third, many methods assume that the delay of each gate or wire is available as a probability distribution function with arbitrary correlations between the various delays, but do not provide an efficient means for deriving such models. Fourth, prior art methods often compute discrete points on the probability distribution of the performance of the circuit as opposed to computing the entire probability distribution. The prior art fails to gain knowledge of the entire distribution that would be advantageous in design for manufacturability, and yield/profit modeling and optimization of the integrated circuit or integrated circuit macro. Finally, prior art methods do not provide a full methodology or flow for statistical modeling and timing of integrated circuits, going from process variations all the way to predicting variations in the performance of integrated circuits.

### OBJECTS OF THE INVENTION

An object of this invention is an improved system and method for modeling and predicting the timing of (integrated) circuits in the face of manufacturing and environmental variations.

It is another object of this invention to provide a system and method for creating statistical timing models of individual gates in a gate library.

It is still another object of this invention to compute efficiently the sensitivity of the coefficients of analytic delay models with respect to sources of parameter variations.

It is yet another object to use timing models of individual gates along with relevant sensitivity information to carry out a statistical timing analysis of an integrated circuit or macro of an integrated circuit.

It is a further object to compute the probability distribution of the slack of the critical path of an integrated circuit or integrated circuit macro.

It is a more particular object to predict the yield of an integrated circuit or integrated circuit macro at a given performance specification.

It is another particular object to predict the profit from an integrated circuit or integrated circuit macro.

It is yet another particular object to predict the maximum performance of an integrated circuit or integrated circuit macro given a required yield.

It is a further particular object to predict the impact of a change in the design or manufacturing process or equipment on the statistical performance, yield and profitability of a circuit.

### SUMMARY OF THE INVENTION

This invention describes a system, method, and program product that provide a comprehensive methodology for statistical modeling and timing of integrated circuits and integrated circuit macros. More specifically, it provides a means for efficiently computing the sensitivities of gate delay models (and their coefficients) to sources of parameter variations. These sensitivities are used to determine the probability distribution of the delay and slew of each gate and wire, as well as the correlations between these delays and slews. In some preferred embodiments, these timing models are used in an inventive statistical static timing analysis method to predict the statistical performance of an integrated circuit or integrated circuit macro.

### BRIEF DESCRIPTION OF THE FIGURES

The foregoing and other objects, aspects, and advantages will be better understood from the following non-limiting detailed description of preferred embodiments of the invention with reference to the drawings that include the following:

FIG. 1 is a process flow diagram showing typical prior art methodology of nominal modeling and static timing of an integrated circuit or integrated circuit macro.

FIG. 2(a) is a non-limiting, prior art example diagram of a single transition of a sample 3-input NAND gate.

FIG. 2(b) shows the waveforms of an example single transition and the definition of output delay and slew for the simple 3-input NAND gate of FIG. 2(a).

FIG. 2(c) is a diagram showing the set of edges contributed by the sample gate of FIG. 2(a) to the example timing graph of a circuit in which this gate occurs.

FIG. 3 is a process flow diagram showing one preferred embodiment of the inventive methodology for statistical modeling and static timing of a circuit, e.g., an integrated circuit or integrated circuit macro.

FIG. 4 is a flow chart of a preferred process of determining the sensitivity of gate timing model coefficients of a single transition of a gate with respect to all sources of variation.

FIG. 5 is a flow chart of a preferred embodiment of a novel statistical static timing procedure.

### DETAILED DESCRIPTION OF THE INVENTION

While the present invention can be applied to any general circuit analysis, the preferred embodiment of the invention involves a method of creating statistical timing models for electrical circuit gates such as NAND and NOR gates, and more preferably then using these statistical timing models in a process of statistical static timing analysis to predict the statistical timing properties of an integrated circuit or integrated circuit macro. Thus this disclosure will describe the use of the invention in integrated circuit design without loss of generality.

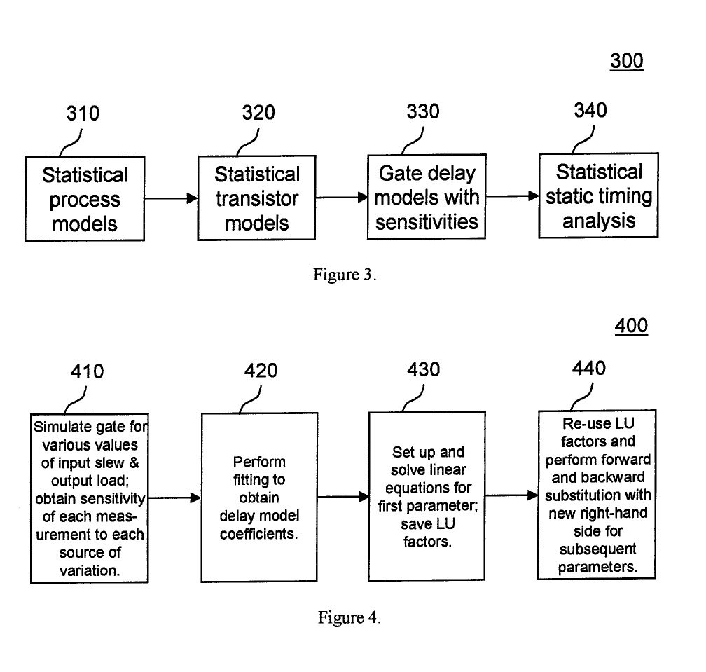

FIG. 3 shows a process flow diagram for statistical modeling and static timing 300. It is assumed that statistical process models (box 310), and transistor models (box 320) are available from well-known prior-art techniques (see, for example, C. Yu, T. Maung, C. J. Spanos, D. S. Boning, J. E. Chung, H. -Y. Liu, K. -J. Chang and D. J. Bartelink, “Use of short-loop electrical measurements for yield improvement,” IEEE Transactions on Semiconductor Manufacturing, vol. 8, number 2, May 1995, pages 150-159). This invention focuses on the creation of gate delay models along with relevant sensitivity information (box 330 and FIG. 4, below) and statistical static timing analysis (box 340 and process 500, below).

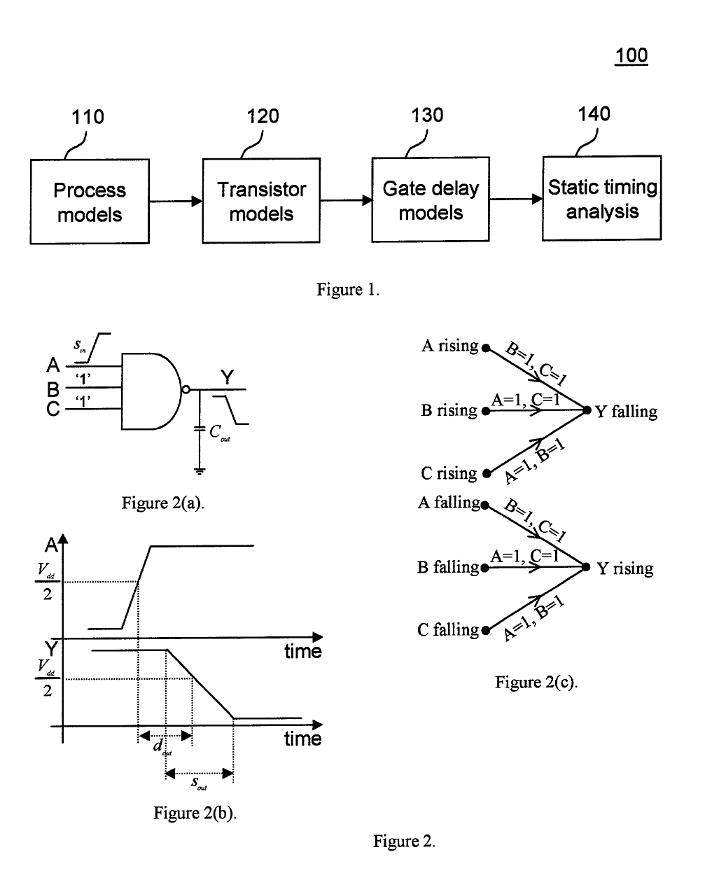

We begin by describing the steps involved in creating gate delay models with relevant sensitivity information (box 330). These will later be employed to conduct statistical timing analysis (box 340 and process 500). Typically (as indicated by Box 130 of FIG. 1), the actual behavior of the circuit, in a preferred embodiment, the set of timing properties of all members of a gate library, is characterized by repeatedly running a circuit simulation program, using the steps described below. First, an analytical form is decided upon to model (or predict) each timing behavior, such as delay and output slew. The analytical form is usually a polynomial. The model arguments are typically input slew and output capacitance, but could also include ambient temperature and power-supply voltage, for example. The predictive model is a function of these model arguments and tunable coefficients. The model arguments are then sampled at a multiplicity of sample value points, and a circuit simulation program is employed at each sample value point to determine the actual timing behavior of the circuit. Curve fitting or regression fitting is then used on all the collected data. In the fitting procedure, the tunable coefficients are adjusted to minimize the difference between the actual behavior and predicted behavior over all of the sample value points. At the end of this procedure, each actual timing behavior can be modeled or predicted as an analytic function of model arguments with known, constant coefficients. The above procedure is well known and widely practiced.

In practice, timing properties are modeled by different methods, and the models themselves are p created and used in different ways, and the models are functions of different quantities, some of which are subject to variability and others not It is to be understood that the present inventive method can easily be applied to any of these existing methodologies by a practitioner of ordinary skill in the art.

The ensuing description presents a method of determining the timing models along with relevant sensitivity information depicted in box 330 of FIG. 3.

Assume that a timing property such as the delay of a pin-to-pin transition of a particular gate's predicted behavior is modeled by the following predictive model:

d_{pred}(aᵢ,sᵢₙ,Cₒᵤₜ),

where d_{pred} is the predicted timing property (or generally a measure of predictive behavior), aᵢ are a set of m tunable coefficients of the model, sᵢₙ is the input slew, Cₒᵤₜ is the output load (see FIG. 2(a)), and d_{pred} is an analytic, possibly nonlinear function, i.e., the timing model. For multiple, say n, preselected sample value points of input slew and output load (set of one or more model arguments), the gate is simulated with a circuit simulator to obtain a set of n measurements that we call d_{actual}.

The model d_{pred} is now tuned or adjusted (the tunable coefficients, aᵢ, are changed) to approximate the actual behavior, d_{actual}, that is obtained from the simulator (or other source of actual behavior information). To do this, any curve fitting method could be used. In the preferred embodiment, the process of fitting involves adjusting the coefficients aᵢ in order to minimize the least squared error. Specifically, the error

$$E = {\sum }_{j = 1}^{n} {[ {d}_{actual}^{j} - {d}_{pred}^{j} ]}^{2}$$

where the superscript, j, indicates the measurement number, i.e., the index identifying the sample point. By minimizing this error, the coefficients of the gate timing model, d_{pred}, are obtained. Now, we are interested in finding the complete sensitivity of d_{pred} to all relevant sources of parameter variation, be they manufacturing variations or environmental variations.

Assume that all sources of parameter variation are collected in a vector P with variations denoted by δP. Then the first-order change in the predicted delay δd_{pred} can be expressed as

$$δ {d}_{pred} = {[ \frac{\partial {d}_{pred}}{\partial P} ]}^{T} δ P$$

where the complete differential can be expanded as

$$δ {d}_{pred} = {[ \{ {\sum }_{i = 1}^{m} \frac{\partial {d}_{pred}}{\partial {a}_{i}} \frac{\partial {a}_{i}}{\partial P} \} + \frac{\partial {d}_{pred}}{\partial {s}_{i n}} \frac{\partial {s}_{i n}}{\partial P} + \frac{\partial {d}_{pred}}{\partial {C}_{out}} \frac{\partial {C}_{out}}{\partial P} ]}^{T} δ P .$$

The term in the square brackets above is the total sensitivity of d_{pred} to P. Obviously, to compute this total sensitivity, we require ∂aᵢ/∂P, i=1,2, . . . , m, which are the sensitivities of the tunable coefficients of the delay model to the sources of variation. One inventive method of determining and applying these sensitivities is described below. Note that computing these sensitivities by perturbation or finite differencing is both prohibitively expensive and numerically dangerous. Each source of variation would have to be perturbed sequentially, and the measuring and fitting procedure repeated for each source of variation. Numerical problems could be encountered because of the noisiness of the circuit simulator and because of finite-precision computer arithmetic. The amount of the perturbation is also crucial. If the perturbation is too small, numerical problems can result because of division by small quantities. If the perturbation is too large, we are computing a poor approximation to the sensitivity. Thus we would like to determine the required sensitivities without resorting to perturbation or finite differencing.

Differentiating the above expression for E with respect to a particular coefficient aᵢ, we obtain

$$\frac{\partial E}{\partial {a}_{i}} = {\sum }_{j = 1}^{n} 2 [ {d}_{actual}^{j} - {d}_{pred}^{j} ] \frac{\partial {d}_{pred}^{j}}{\partial {a}_{i}} = 0.$$

The fitting procedure ensures that E is at a minimum with respect to each aᵢ and hence the gradient of E with respect to each aᵢ is zero.

We now differentiate the above equation with respect to a parameter p, a source of variation (such as the effective length of a transistor), to obtain

$${\sum }_{j = 1}^{n} 2 [ \frac{\partial {d}_{actual}^{j}}{\partial p} - \frac{\partial {d}_{pred}^{j}}{\partial p} ] \frac{\partial {d}_{pred}^{j}}{\partial {a}_{i}} = 0.$$

This represents the conditions under which the tunable coefficients yield a minimum model error irrespective of any source of variation. No matter what the parameter variations, this relation will be satisfied to guarantee minimum (least squares) error.

Note that

$$\frac{\partial {d}_{pred}^{j}}{\partial {a}_{i}}$$

is not a function of p since we assume that even though p shows variations, the sample slew and output load values at which d_{actual} is measured are not changed, i.e.,

$$\frac{\partial {d}_{pred}^{j}}{\partial {a}_{i}}$$

depends on the values of the sample points which are independent of the sources of variation. Only the tunable coefficients of the model depend on the sources of variation. Also, since the delay model is a polynomial with coefficients aᵢ, i=1,2, . . . , m,

$$\frac{\partial {d}_{pred}^{j}}{\partial {a}_{i}}$$

is not a function of the aᵢ coefficients either. This is because the tunable coefficients appear linearly in the polynomial model. Since d_{pred} is a function of aᵢ, which are in turn functions of p, we can write by simple chain-ruling:

$${\sum }_{j = 1}^{n} 2 [ \frac{\partial {d}_{actual}^{j}}{\partial p} - \{ {\sum }_{k = 1}^{m} \frac{\partial {d}_{pred}^{j}}{\partial {a}_{k}} \frac{\partial {a}_{k}}{\partial p} \} ] \frac{\partial {d}_{pred}^{j}}{\partial {a}_{i}} = 0.$$

Note that the left hand side consists of a summation of terms in which we differentiate at each of the n pairs of sample value points for s^{j}ᵢₙ and C^{j}ₒᵤₜ which are considered constant and independent of the parameter variations.

Rearranging terms and dividing by 2, we obtain

$${\sum }_{j = 1}^{n} [ \frac{\partial {d}_{pred}^{j}}{\partial {a}_{i}} \{ {\sum }_{k = 1}^{m} ( \frac{\partial {d}_{pred}^{j}}{\partial {a}_{k}} \frac{\partial {a}_{k}}{\partial p} ) \} ] = {\sum }_{j = 1}^{n} [ \frac{\partial {d}_{actual}^{j}}{\partial p} \frac{\partial {d}_{pred}^{j}}{\partial {a}_{i}} ] , \\ i = 1 , 2 , ⋯ , m .$$

Since we can perform the above differentiation and manipulation with respect to each of m coefficients, we obtain m equations like the one above. The left-hand side of these equations is simply a linear combination of the

$$\frac{\partial {a}_{k}}{\partial p}$$

terms, which are our unknowns. The coefficients of these terms,

$$\frac{\partial {d}_{pred}^{j}}{\partial {a}_{k}} ,$$

the sensitivity of the model (or predicted behavior) with respect to each tunable coefficient, aₖ, are easily evaluated as constants at each of the n sample value points.

Assume that the circuit simulator is able to provide the sensitivity

$$\frac{\partial {d}_{actual}^{j}}{\partial p}$$

of each measurement (actual behavior) with respect to p, the parameter which shows variability. Then the right-hand sides of the equations are known. Thus we end up with m linear equations in m unknowns that can be solved to obtain the sensitivity of the tunable coefficients of the delay model with respect to one variable parameter of interest,

$$\frac{\partial {a}_{i}}{\partial p} .$$

The physical significance of the above equation is as follows: if a parameter, p, has a small variation, δp, the delay measurements will change. If the fitting procedure were to be repeated with the changed measurements, it would lead to changed tunable coefficients, aᵢ. The relationship between the change in the coefficient values and the variation of the parameter is given by the above equation, without having to repeat either the measurements or the fitting procedure. This is in contrast with prior-art perturbation methods.

Now we consider the situation with multiple variable parameters. The above analysis can easily be repeated for a second parameter. Interestingly, the left-hand-side coefficients are unchanged, and only the right-hand-side vector is changed since the sensitivities of d_{actual} to the second parameter will be different. As before, even in the case of multiple parameter variations, the sensitivities of the delay coefficients to the multiple parameter variations are governed by the equation above without having to repeat either the measurements or the fitting procedure. Thus if the linear equations for the first parameter were solved by the well-known LU (Lower-triangular/Upper-triangular) factorization method, the LU factors obtained can be reused for the second and every subsequent source of variability. Only forward and backward substitution steps are required to obtain the sensitivities of the coefficients of the delay equations to the second and every subsequent parameter! It is well known that the factorization step is much more computationally expensive than forward and backward substitution. Hence, the computational effort required for each subsequent parameter is a small additional overhead after the initial LU factorization. The inventive method thus allows a significant reduction in computational effort over any prior-art method for the case of multiple parameter variations. LU factorization is a well-known procedure, described for example in Chapter 3 of L. T. Pillage, R. A. Rohrer and C. Visweswariah, “Electronic Circuit and System Simulation Methods,” McGraw Hill, 1995.

Finally, we note that the preferred method of computing sensitivities of the measurements with respect to the multiple sources of variation in the circuit simulator is by the adjoint method (see S. W. Director and R. A. Rohrer, “The generalized adjoint network and network sensitivities,” IEEE Transactions on Circuit Theory, vol. CT-16, number 3, pages 318-323, August, 1969), in which the sensitivity of a measurement with respect to multiple parameters can be computed by means of a single adjoint analysis.

A further preferred method of efficiently determining the measurements (actual timing behavior) and the sensitivities of the measurements to the sources of variation is described below.

Consider a library that has a number of gate types (e.g., inverter, NAND, NOR), each of which is available with various combinations of transistor sizes (i.e., a number of power levels, β ratios and taper ratios). We will call each unique gate in the library (representing a unique combination of circuit topology and transistor sizes) a cell. The characterization process requires us to model the timing of each edge of the timing graph contributed by each cell. For each such edge, we must simulate the cell at a multiplicity of preselected sample value points of input slew and output capacitance, and at each sample value measure the delay, output slew, and sensitivities of delay and output slew to all sources of variation. One way to do this is to invoke a separate circuit simulation for each sample value, carrying out an adjoint analysis in addition to each nominal circuit simulation. Another way to do this is to concatenate in time the simulation at multiple sample point values to form groups of simulations. For example, the four single-input transitions of a 2-input NAND gate can be measured in a single simulation by cycling the inputs through patterns such as A=11101, B=10111. Further, the simulations for multiple input slews can then be further concatenated in time. Concatenation in time saves the computer time required by the circuit simulator to set up the circuit equations and perform a DC analysis from scratch for each new simulation. Thus the setup and DC analysis computer time is leveraged over all the measurements in a group.

Concatenation in time also vastly improves the efficiency of computing the sensitivities of the measurements to sources of variation. The right-hand-side of the final set of equations above can be thought of as a linear combination of the sensitivities of individual measurements to sources of variation, or in fact the sensitivity of a linear combination of individual measurements. The coefficients of the linear combination are known once the nominal simulations have been performed. Even better, this linear combination is the same for all sources of variation. We will call this linear combination of individual measurements a scalar function. What we desire is the sensitivity not of individual measurements but of the scalar function, with respect to each source of variation.

The sensitivity of any scalar and differentiable function of multiple measurements with respect to any number of sources of variation can be computed in a single adjoint analysis (see A. R. Conn, R. A. Haring and C. Visweswariah, “Method of efficient gradient computation,” U.S. Pat. No. 5,886,908, issued March 1999). Thus grouping all the measurements to be simulated and time-concatenating within each group saves computer time both in recording measurements and in determining the sensitivities of the measurements.

Of course, there are some practical limitations to this type of grouping. Cells of different gate types cannot be grouped. On occasion, the overhead of an extra pattern or vector of simulation may be required to bring the inputs and internal nodes of the gate to the logical state required to make the next required transition. Measurements at multiple sample values of input slew can easily be concatenated in time. Depending on the limitations of the circuit simulator employed, there may be other constraints in deciding which measurements to concatenate.

Within these limitations, the maximal grouping will buy the most gains in computer efficiency during the library characterization process.

The steps involved in computing sensitivities of delay model coefficients of a single pin-to-pin transition of a single library gate with respect to variation parameters are shown in the flow diagram 400 of FIG. 4. In step 410, the circuit simulator is employed to take measurements at numerous sample value points of sᵢₙ and Cₒᵤₜ (the model arguments), and to compute the sensitivities of each of these measurements of actual timing behavior to the sources of parameter variation, preferably by the adjoint method and preferably using grouping and time-concatenation. In box 420, curve fitting is performed by well-known prior art methods to minimize the least squares error between the predicted and measured delays. In box 430, a set of linear equations is formed by the inventive method with sensitivities of the tunable delay coefficients to the first variation parameter as the unknowns. These equations are then solved by the well-known LU factorization method. In box 440, the LU factors are repeatedly used with different right-hand side values to compute sensitivities with respect to subsequent variable parameters efficiently.

The steps of the flow chart of FIG. 4 are repeated for every pin-to-pin transition of every member of the circuit library to obtain the sensitivities of all the delay coefficients to each of the sources of parameter variation. Depending on the details of the delay model, the above procedure must be repeated for each aspect of the timing model such as output delay and output slew. Referring back to FIG. 3, all of the procedure of FIG. 4 applied to every pin-to-pin transition of every member of the circuit library enables us to determine the gate delay models along with relevant sensitivities as indicated in Box 330 of FIG. 3. In other words, repeatedly applying the steps of FIG. 4 results in accomplishment of Box 330 of FIG. 3.

Now we describe an alternative embodiment of this invention, which is a method of statistical static timing analysis, shown as Box 340 of FIG. 3. In this part of the embodiment, we assume that timing models along with relevant sensitivity information are available for each edge of the timing graph. These models are preferably but not necessarily computed by the inventive method described above in FIG. 4. However, any prior-art timing model could be used including timing models expressed in the DCL language (see “IEEE standard for integrated circuit (IC) delay and power calculation system,” IEEE Standard 1481-1999, 1999, pages 1-390, available at http://fb.ieeexplore.ieee.org/ie15/6837/18380/00846710.pdf?isNumber=18380&prod=standards& arnumber=00846710).

In the ensuing detailed description, we will assume that the circuit is a combinational circuit whose timing can be represented by a directed acyclic graph (DAG) and that we are interested in late-mode delays only. The nodes of the graph are the rising and falling signals of the circuit, and all pin-to-pin input-to-output transition delays of all gates and wires are the edges of the graph. It is to be understood that while these simplifications are made to clarify the exposition, the extension to early-mode analysis, to circuits with different kinds of latches, to dynamic circuits, to circuits with loops of transparent latches, and to situations dealing with slack instead of delay can be accomplished by one of ordinary skill in the art.

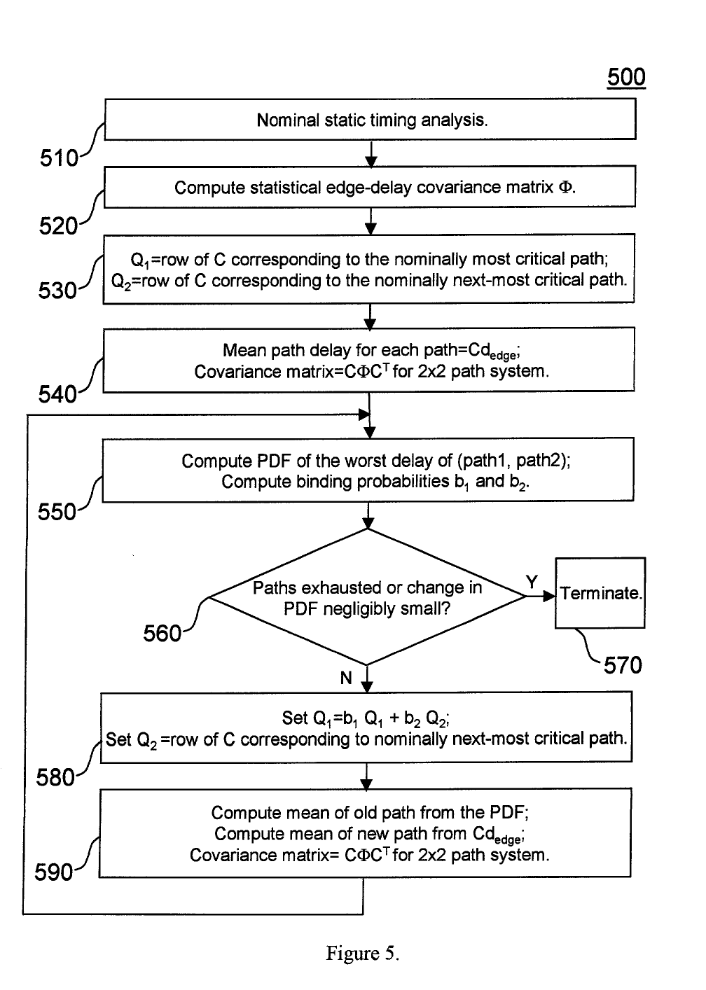

FIG. 5 shows a flow chart (500) of the steps involved in the inventive method of a statistical timing analysis process. In other words, the details of Box 340 of FIG. 3 can be found in flow chart 500 of FIG. 5. The individual steps are explained in detail in the subsequent paragraphs. Note that any circuit delay model that provides sensitivities of the tunable coefficients with a respect to the sources of variation (330) can be used with process 500. However, the process 330 described above is preferred.

The essence of the procedure (500) is to recursively consider two paths through the circuit at a time and determine the probability density function (PDF) of the maximum delay of the two paths, taking into account the covariance of the delay of the two paths. To generally address the effects of any given source of variation, covariance must be accounted for because two or more of the paths are likely to be commonly influenced by the source of variation. There are two main reasons for this correlation. The first is that the two paths may share one or more wires or gates, and so the path delays show correlation. The second is that all paths are exposed to the same or similar manufacturing and environmental variations. For example, all paths will be exposed to the same oven temperature during manufacturing. Thus the paths would be expected to exhibit behavior with a common influence (correlation) as a result. As this procedure continues, an edge criticality vector Q of the probability of each edge being critical is maintained.

The process begins with a nominal static timing analysis by prior art methods (510). These static timing analysis methods provide the list of nominally most-critical paths in order of criticality and the nominal slack of each of these paths. The next step (520) is to determine the matrix Φ (a square matrix of size number of edges by number of edges) which represents the variance and covariance of all the edges of the timing graph which was constructed during the nominal static timing analysis. Let us denote by δd_{pred} the change in predicted delay as a consequence of the statistical manufacturing and environmental parameter variations (collectively the “sources of variation”). Step 520 obtains statistical parameters like the variance of δd_{pred} of a single edge in the delay graph. For instance, given the covariance matrix of all parameter variations, denoted by V, the variance of δd_{pred}, denoted by σ²(d_{pred}), can be obtained by applying the gradient vectors appropriately as shown below:

$${σ}^{2} ( {d}_{pred} ) = {[ \frac{\partial {d}_{pred}}{\partial P} ]}^{T} V [ \frac{\partial {d}_{pred}}{\partial P} ] .$$

Assuming two different edges (associated with the same or different gates), say edge i and edge k, and assuming that the covariance matrix V covers all parameter variations relevant to both edges, then the covariance of δd_{pred}ⁱ and δd_{pred}^{k} denoted by the statistical expectation E

$$E [ δ {d}_{pred}^{i} \cdot δ {d}_{pred}^{k} ]$$

is readily determined by

$$E [ δ {d}_{pred}^{i} \cdot δ {d}_{pred}^{k} ] = {[ \frac{\partial {d}_{pred}^{i}}{\partial P} ]}^{T} V [ \frac{\partial {d}_{pred}^{k}}{\partial P} ] .$$

Thus the variances and correlations that make up the matrix Φ are determined in box 520.

The matrix C is built (step 530) that is a sparse path-edge matrix that contains only 1s and 0s. Each path is represented by a row that contains a 1 in columns corresponding to edges in the path and a zero in columns corresponding to all other edges. The paths are sorted by criticality (530). As a practical matter, such a large matrix is never built or computed; rather, it is used here for notational convenience. The mean delays of paths are simply

dₚₐₜₕ=Cd_{edge}

where dₚₐₜₕ is a vector of mean path delays and d_{edge} the vector of mean edge delays.

We take the nominally two most critical paths of the circuit, since they have the highest probability of contributing to the probability density function of the most critical path However, the method will work (perhaps less efficiently) irrespective of the path order chosen. We call the rows of C corresponding to these paths Q₁ and Q₂, respectively (step 530). Using these two rows, we can compute the 2×2 submatrix of CΦC^{T} (step 540). The edge delays are assumed to be distributed as multivariate normal distributions. Thus the means, variances and the covariance of the two paths being considered are now known. It is to be noted that because of the sparsity and special structure of C, the product CΦC^{T} can be computed efficiently.

The next step (550) is to compute the probability density function of the worst delay of the two paths being considered. The probability that the first path is binding (i.e., dominates the timing of the other path) and has a delay of η is

$$\frac{1}{\sqrt{2 Π}} \frac{1}{{σ}_{1}} {ⅇ}^{- \frac{{( η - {μ}_{1} )}^{2}}{{σ}_{1}^{2}}} erf ( \frac{\frac{η - {μ}_{2}}{{σ}_{2}} - \frac{η - {μ}_{1}}{{σ}_{1}} ρ}{\sqrt{1 - {ρ}^{2}}} ) ,$$

where

$$COV ( path1 , path2 ) = [ \begin{matrix}{σ}_{1}^{2} & {σ}_{1} {σ}_{2} ρ \\ {σ}_{1} {σ}_{2} ρ & {σ}_{2}^{2}\end{matrix} ]$$

and μ₁ and μ₂ are the mean delays of the two paths and the covariance matrix determined in step 540 allows us to determine σ₁, σ₂ and ρ. Likewise, we can write the probability that path 2 dominates and has a particular delay. The summation of these two probability distributions over all values of η gives us the required probability distribution function. The resulting probability distribution function is normalized by computing its mean and variance, and then approximated by a normal distribution with the same mean and variance values (step 550). Further, the integral of the probability that path 1 dominates path 2 over all values of η gives us the total “binding probability” that path 1 dominates (step 550). The physical significance of the computed PDF is that if the circuit were to consist of only the paths considered thus far, the circuit would have a critical path delay as predicted by the probability density function. Further, the binding probabilities tell us the probabilities that the critical path delay is limited by the first path or the second, and, of course, the two binding probabilities add up to 1. The above probability calculations are well-known, see for example P. Z. Peebles, Jr., “Probability, random variables, and random signal principles,” McGraw Hill, Second Edition, 1987. A check is made (step 560). If the paths of the circuit are exhausted or the change in the probability density function is negligibly small compared to the desired accuracy, the process 500 terminates (step 570). If not, the process continues to step 580.

The next step (580) is to update our vector of edge criticality probabilities by setting

Q₁=Q₁b₁+Q₂b₂

to represent the cumulative edge criticality probabilities thus far. There is no approximation involved in the above formula since the probability that an edge is critical is the sum of the probabilities that each path that includes this edge is critical. Q₁ represents the vector of edge criticality probabilities considering only the set of paths processed so far, and b₁ is the probability that one of the paths from this set is critical (or binding). Similarly, Q₂ represents the vector of edge criticality probabilities of the next path being considered (a vector of 1s and 0s), and b₂ is the probability that that path is critical.

We then repeat the above recursive procedure by computing the required means, variances and covariances (step 590) and then returning to step 550. At some point, we will either run out of paths or the change in the probability distribution function will be negligibly small (step 560). At this point, the procedure terminates (step 570), and thus the statistical timing analysis (box 340 of FIG. 3) will have been accomplished.

The above method can advantageously be combined with “uncertainty-aware tuning” to render it more efficient. If the circuit undergoes “uncertainty-aware tuning” before the statistical static timing analysis, then there will be relatively few critical paths that must be considered since the “wall” of equally critical paths is avoided. Thus the statistical timing analysis procedure can be terminated earlier, and the inaccuracy due to the approximation of making the PDF Gaussian at each path-merging recursion will be reduced. Uncertainty-aware tuning is described in X. Bai, C. Visweswariah, P. N. Strenski and D. J. Hathaway, “Uncertainty-aware circuit optimization,” Proceedings of the Design Automation Conference, June 2002, New Orleans, La. and also in C. Visweswariah, X. Bai, D. J. Hathaway and P. N. Strenski, “Parameter variation tolerant method for circuit design optimization,” U.S. patent application filed May 2002, Docket FIS9-2002-0034-US1.

Once we have the probability distribution function of the most critical delay of the circuit, the information can be used in several interesting ways. We can predict the yield of the circuit at a given performance requirement. Since we have the full PDF of the critical path delay, we simply accumulate the probability that the circuit has the required performance or better to obtain the yield. More specifically, for instance, given a maximum delay dₘₐₓ that can be tolerated, we compute the percentage of circuits exhibiting a delay not larger than dₘₐₓ which would be the required yield. We can also calculate the performance requirement in order to guarantee a certain yield. To do this, we simply compute the cumulative probability distribution by integrating the PDF and then sample the cumulative probability distribution at the required yield to obtain the performance of the circuit that would guarantee the required yield.

We can also obtain the final probability of each edge being critical. To do this, we simply inspect the Q₁ vector of binding probabilities at the end of the statistical timing. We can also compute the probability that a particular path dominates the timing of the circuit. To do so, we simply accumulate an updated binding probability for each considered path as the statistical timing analysis proceeds. The accumulation implies the product of the binding probabilities that any group of paths that includes the path of interest is binding. All of the above probabilities are extremely useful in guiding circuit optimization techniques to improve performance and/or yield and/or profitability.

It is to be understood that the same techniques can be applied with slight modification to early mode timing in which we seek to find the earliest time at which a signal changes from the stable logical value of the previous cycle of operation. In early mode, the fastest path dominates the timing of the circuit. The previously described procedure can be repeated with two minor changes. Given two paths, path 1 and path 2, the probability that the first path is binding (i.e., dominates the timing of the other path) and has a delay of η is

$$\begin{matrix} & & & \frac{1}{\sqrt{2 Π}} \frac{1}{{σ}_{1}} {ⅇ}^{- \frac{{( η - {μ}_{1} )}^{2}}{{σ}_{1}^{2}}} [ 1 - erf ( \frac{\frac{η - {μ}_{2}}{{σ}_{2}} - \frac{η - {μ}_{1}}{{σ}_{1}} ρ}{\sqrt{1 - {ρ}^{2}}} ) ] , \\ where & & & \\ & & & COV ( path1 , path2 ) = [ \begin{matrix}{σ}_{1}^{2} & {σ}_{1} {σ}_{2} ρ \\ {σ}_{1} {σ}_{2} ρ & {σ}_{2}^{2}\end{matrix} ]\end{matrix}$$

and μ₁ and μ₂ are the mean early-mode delays of the two paths and the covariance matrix determined in step 540 allows us to determine σ₁, σ₂ and ρ. Likewise, we can write the probability that path 2 dominates and has a particular delay. The summation of these two probability distributions over all values of η gives us the required probability distribution function. The binding probabilities are then computed in a similar fashion to the previous procedure, except that the binding probability of a path now represents the probability that the path being considered has the lowest delay among all the paths considered thus far. So, other than computing the PDF and binding probabilities in a slightly different manner, the procedure for statistical static timing in early mode is similar to that for late mode.

We claim:

1. A method for developing a statistical behavioural model of an electrical circuit comprising the steps of:
identifying one or more sources of variation that can cause a change in the behavior of the electrical circuit;
using a circuit simulator, measuring a set of one or more actual behaviors of the electrical circuit at one or more respective sample points, each sample point being defined by a set of one or more model arguments, the model arguments being characteristics of the electrical circuit that effect the behavior;
determining one or more measurement sensitivities of each actual behavior with respect to each of the one or more sources of variation;
developing a model of the electrical circuit to determine a predictive behavior, the model having one or more tunable coefficients, the tunable coefficients being varied to minimize the error between each of the actual behaviors and a respective predictive behavior at all of the sample points, the predictive behavior being predicted by the model;
determining one or more sensitivities of the model with respect to each of the one or more tunable coefficients at each sample point; and
for each source of variation, obtaining a sensitivity of the tunable coefficients to the respective source of variation.

2. A method, as in claim 1, where the sources of variation include any one or more of the following: a manufacturing variation, an environmental variation, a temperature, a material, a material property, a circuit component geometry, a physical characteristic, an oven temperature, a junction depth, a concentration of doping impurities, contamination in a clean room, dust contamination in the clean room, a mechanical tolerance, a lens aberration, an inhomogeneous gas flow, a variation in gas pressure, a control of temperature, a deposition failure, a deposition failure with spinning, a surface planarity, a control of machines in the fabrication line, a mechanical tolerance, a deposition difference, a line width, a doping.

3. A method, as in claim 1, where the model arguments include any one or more of the following: a circuit input slew, a circuit output capacitance, temperature of operation and power-supply voltage.

4. A method, as in claim 1, where the actual behavior includes any one or more of the following: a circuit timing property, a power, a gain, an amplification, a noise rejection ratio, and a noise figure of merit.

5. The method of claim 1, where the actual behavior is a timing behavior of a gate circuit and the timing model of the gate comprises a delay and slew model for each of one or more pin-to-pin transitions of the electrical circuit.

6. The method of claim 1, where one or more of the model arguments varies with a change of one or more of the sources of variation.

7. The method of claim 1, where the measurement sensitivities with respect to one or more of the sources of variation are determined by an adjoint method.

8. The method of claim 1, where the measurements and measurement sensitivities with respect to one or more of the sources of variations are determined by time-concatenation and the adjoint method.

9. The method of claim 1, where one or more of the sensitivities of the tunable coefficients to the sources of variation are determined by solving a set of linear equations with one LU factorization and subsequent forward and backward substitutions.

10. A method, as in claim 1, further comprising the step of:
combining the sensitivities of each of the one or more tunable coefficients with respect to each of the one or more sources of variation with the variances and covariances of the sources of variation to obtain the variances and covariances of the timing model of the electrical circuit.

11. The method of claim 1, where the error is minimized by a least squares method.

12. The method of claim 1, where the electrical circuit is a microelectronic circuit.

13. A system for developing a statistical behavior model of an electrical circuit comprising:
means for identifying one or more sources of variation that can cause a change in the behavior of the electrical circuit;
means for using a circuit simulator to measure a set of one or more actual behaviors of the electrical circuit at one or more respective sample points, each sample point being defined by a set of one or more model arguments, the model arguments being characteristics of the electrical circuit that effect the behavior;
means for determining one or more measurement sensitivities of each actual behavior with respect to each of the one or more sources of variation;
means for developing a model of the electrical circuit to determine a predictive behavior, the model having one or more tunable coefficients, the tunable coefficients being varied to minimize the error between each of the actual behaviors and a respective predictive behavior at all of the sample points, the predictive behavior being predicted by the model;
means for determining one or more sensitivities of the model with respect to each of the one or more tunable coefficients at each sample point; and
means for obtaining a sensitivity of the tunable coefficients to the respective source of variation, for each source of variation.

14. A system for developing a statistical behavior model of an electrical circuit comprising:
an identifier that identifies one or more sources of variation that can cause a change in the behavior of the electrical circuit;
circuit simulator measurements being a set of one or more actual behaviors of the electrical circuit at one or more respective sample points, each sample point being defined by a set of one or more model arguments, the model arguments being characteristics of the electrical circuit that effect the behavior;
a sensitivity measurement of one or more measurement sensitivities of each actual behavior with respect to each of the sources of variation;
a model of the electrical circuit to determine a predictive behavior, the model having one or more tunable coefficients, the tunable coefficients being varied to minimize the error between each of the actual behaviors and a respective predictive behavior at all of the sample points, the predictive behavior being predicted by the model, the model being capable of providing one or more sensitivities of the model with respect to each of the one or more tunable coefficients at each sample point; and
a sensitivity of the tunable coefficients to the respective source of variation, for each source of variation, the sensitivity of the tunable coefficients derived from a system of relationships.

15. A method of computing the probability density function of the late-mode timing slack of a circuit, comprising the steps of:
A. representing the circuit by a timing graph, the timing graph having one or more edges, each edge representing the timing behavior of a pin-to-pin transition of the gates and wires of the circuit and the timing graph having nodes, each node representing the timing behavior of a rising or falling signal of the circuit;
B. conducting a nominal static timing analysis using the mean value timing properties of each edge of the graph;
C. creating a statistical timing model for each edge of the graph that determines the variance of each edge and the covariance of each pair of edges;
D. selecting one path according to a criticality factor;
E. selecting a second path according to a criticality factor;
F. determining a statistical model for the mean, variance and covariance of the slack of the two selected paths;
G. creating a combined probability density function of the minimum slack of these two paths and computing the probability that each of these paths is critical, being the binding probability of each respective selected path dominating the other;
H. determining an edge criticality probability vector that contains the probability that each edge of the timing graph is critical based on the set of paths considered so far, so that all paths considered so far are treated as a current single selected path;
I. repeating steps E, F, G and H until the occurrence of one of the following:
a. all the paths are exhausted; and
b. the change in the probability density function of the most critical slack is less than a tolerance.
J. selecting the last combined probability distribution function as representative of the statistical timing behavior of the circuit.

16. The method of claim 15, where the probability distribution function of early-mode slack is determined.

17. The method of claim 15, where the criticality factor for path selection is in order of late-mode path criticality.

18. The method of claim 16, where the criticality factor for path selection is in order of early-mode path criticality.

19. The method of claim 15, where the criticality factor for path selection is any order.

20. The method of claim 16, where the criticality factor for path selection is any order.

21. The method of claim 15, where the circuit is any one or more of the following: a microelectronic circuit, a combinational circuit, a sequential circuit without transparent latches, a sequential circuit with transparent latches, a sequential circuit with loops of transparent latches and a dynamic circuit

22. The method of claim 16, where the circuit is any one or more of the following: a microelectronic circuit, a combinational circuit, a sequential circuit without transparent latches, a sequential circuit with transparent latches, a sequential circuit with loops of transparent latches and a dynamic circuit

23. The method of claim 15, where the circuit is first tuned by an uncertainty-aware tuning method to reduce the number of critical paths that must be considered.

24. The method of claim 16, where the circuit is first tuned by an uncertainty-aware tuning method to reduce the number of critical paths that must be considered.

25. The method of claim 15, further comprising the step of integrating the final probability density function to compute the cumulative probability distribution.

26. The method of claim 25, where the cumulative probability distribution is of a minimum early-mode slack.

27. The method of claim 15, where the probability density function of the minimum late-mode slack is used to predict one or more of the following: a parametric yield of the circuit and profitability of the manufacturing process of the circuit.

28. The method of claim 16, where the probability density function of the minimum early-mode slack is used to predict one or more of the following: a parametric yield of the circuit and profitability of the manufacturing process of the circuit.

29. The method of claim 15, where the probability density function of the minimum late-mode slack is used to compute one or more of the following statistical properties of the circuit: a mean value of late-mode slack, a variance of late-mode slack and skewness of late-mode slack.

30. The method of claim 16, where the probability density function of the minimum early-mode slack is used to compute one or more of the following statistical properties of the circuit: a mean value of early-mode slack, a variance of early-mode slack and skewness of early-mode slack.

31. The method of claim 15, where the probability density function of the minimum late-mode slack is used to compute the late-mode performance specifications of a circuit which will have a specific parametric yield.

32. The method of claim 16, where the probability density function of the minimum early-mode slack is used to compute the early-mode performance specifications of a circuit which will have a specific parametric yield.

33. The method of claim 15, in which the probability density function of the minimum late-mode slack is used to evaluate the benefit of one or more of the following: a possible change in the design of the circuit and a possible change in a manufacturing process of the circuit and a possible change in the equipment used in the manufacturing process of the circuit.

34. The method of claim 16, in which the probability density function of the minimum early-mode slack is used to evaluate the benefit of one or more of the following: a possible change in the design of the circuit and a possible change in a manufacturing process of the circuit and a possible change in the equipment used in the manufacturing process of the circuit.
